(19) United States
(12) Patent Application Publication
(10) Pub. No.: US 2025/0117302 A1
(43) Pub. Date: Apr. 10, 2025

(54) CHIP VERIFICATION METHOD BASED ON SPI

(71) Applicant: IPGoal Microelectronics (Sichuan) Co., Ltd., Chengdu (CN)

(72) Inventor: Chuan Yang, Chengdu (CN)

(21) Appl. No.: 18/981,559

(22) Filed: Dec. 15, 2024

(30) Foreign Application Priority Data
Jul. 31, 2024 (CN) 2024110365710

(51) Int. Cl. G06F 11/273; G06F 11/22; G06F 11/263

(52) U.S. Cl. CPC G06F 11/2733; G06F 11/2236; G06F 11/263

(57) ABSTRACT

A chip verification method based on SPI includes steps of (a) obtaining parameter information of a module of a chip under test and a corresponding register; (b) writing a test case for the module; (c) driving the parameter information in the test case onto an SPI bus at a top level of the chip under test through a driver, accessing a register of the module; (d) verifying the access result to determine whether the register is normal; (e) repeating steps (b) to (d) until all registers of the current module have been verified; and (f) repeating steps (a) to (e) until all modules of the chip have been verified. The method does not require using the chip bus to access its registers, thus alleviating the burden on the chip bus, reducing the probability of access errors, and improving the efficiency of chip verification.

### FIELD OF THE INVENTION

The present invention relates to the field of chip verification, and more specifically to a chip verification method based on SPI (Serial Peripheral Interface).

### BACKGROUND OF THE INVENTION

With the continuous improvement of chip manufacturing processes, the number of functional modules integrated within chips has increased, leading to a growing number of registers required overall. Consequently, the verification for chips has become increasingly complex, making the inspection of registers more cumbersome. If all access methods for registers are mixed together, the probability of errors will significantly increase, and it will be challenging to make accurate judgments on the verification results. Previously, most chip registers were accessed directly through a configuration bus. However, as the internal structure of chips becomes more complex and each functional module has multiple dedicated registers, using the conventional method for accessing different registers of different modules is prone to errors, leading to disorganized hierarchical logic that is unsuitable for verifying chips with more complex functions and structures.

Therefore, there is a need to provide an improved verification method that does not require using the chip bus to accessing the registers. The chip verification method based on SPI of the present invention aims to overcome the aforementioned deficiencies.

### SUMMARY OF THE INVENTION

The purpose of the present invention is to provide a chip verification method based on SPI, which does not require using the chip bus to access its registers, thus alleviating the burden on the chip bus, reducing the probability of access errors, and improving the efficiency of chip verification.

To achieve the above objectives, the present invention provides chip verification method based on SPI including the following steps:
(a) obtaining parameter information of a module of a chip under test and a corresponding register within the module;
(b) writing a test case for the module based on the parameter information;
(c) driving the parameter information in the test case onto an SPI bus at a top level of the chip under test through a driver, accessing at least one register of a current module of the chip under test, and obtaining an access result;
(d) verifying the access result to determine whether a current register of the current module is normal;
(e) repeating steps (b) to (d) until all registers of the current module have been verified; and
(f) repeating steps (a) to (e) until all modules of the chip have been verified.

As a preferable embodiment, the method further includes setting whether there is an SPI flash device connected in the chip under test within the test case.

As a preferable embodiment, when an SPI flash device is connected in the chip under test, loading data information from the SPI flash into the registers of the current module of the chip under test by configuring an SPI master register within the chip under test.

As a preferable embodiment, said accessing the at least one register of the current module of the chip under test in step (c) specifically includes accessing the data information of the SPI flash loaded onto the registers.

As a preferable embodiment, when no SPI flash device is connected in the chip under test, said accessing the at least one register of the current module of the chip under test in step (c) specifically includes accessing original data in the registers.

As a preferable embodiment, said accessing the at least one register of the current module of the chip under test in step (c) specifically includes reading data from the registers, writing data to the registers, and reading back the data written.

As a preferable embodiment, step (d) specifically includes comparing the data obtained from the registers with original data to determine consistency; and comparing the data written to the registers with the data read from the registers to determine consistency.

As a preferable embodiment, the parameter information includes chip select instructions of the module and address information of the registers.

In comparison with the prior art, in the chip verification method based on SPI of the present invention, the access to the registers of the chip under test can be accomplished solely through the SPI bus, without relying on the chip bus for access operations. This alleviates the burden the chip bus, allowing the chip bus to perform other operations more efficiently, thus improving the overall performance of the chip. Additionally, in the present invention, the SPI bus is exclusively used for accessing registers, which significantly reduces the probability of errors in accessing registers compared to the chip bus, thereby enhancing the overall verification efficiency of the chip.

### BRIEF DESCRIPTION OF THE DRAWINGS

The accompanying drawings facilitate an understanding of the various embodiments of this invention. In such drawings:

FIG. 1 is a flowchart of a chip verification method based on SPI according to an embodiment of the present invention.

FIG. 2 is a flowchart of the chip verification method of the present invention.

### DETAILED DESCRIPTION OF ILLUSTRATED EMBODIMENTS

Referring to the accompanying drawings, the embodiments of the present invention are described. Similar reference numerals in the drawings represent similar elements. As described above, the present invention provides a chip verification method based on SPI (Serial Peripheral Interface). In this verification method, the registers of the chip can be accessed without depending on the chip bus, thus alleviating the burden on the chip bus, reducing the probability of access errors, and improving the overall efficiency of chip verification.

The chip verification method based on SPI according to the present invention is primarily used for verifying chips which are equipped with an SPI and access registers by the SPI. It is evident that the chip verification method of the present invention is unsuitable for those chips without an SPI, or those have an SPI but do not use it to access registers.

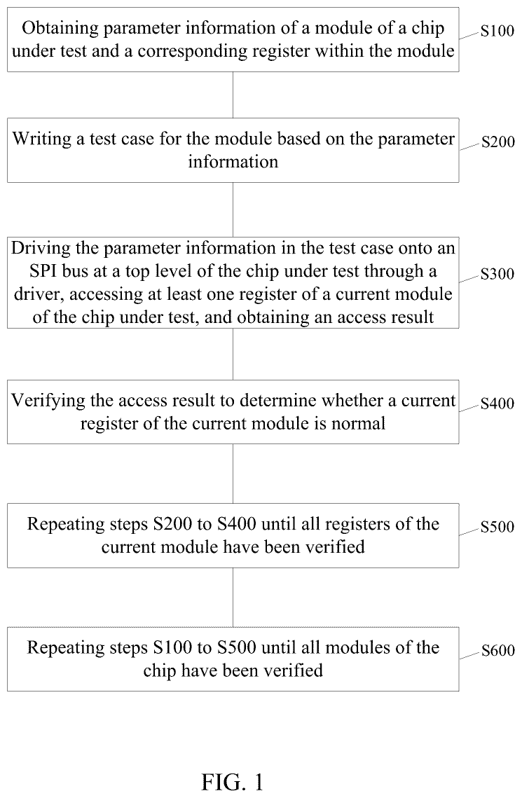

Referring to FIG. 1, which is a flowchart of the chip verification method based on SPI according to the present invention, as shown, the method includes the following steps:

Step S100, obtaining parameter information of a module of a chip under test and a corresponding register within the module. In this step, based on the parameter information for one of the modules and its corresponding register, the module and the register can be accessed and verified. The parameter information includes chip select instructions of the modules and address information of the registers, as well as other parameters needed for verification. Specifically, the chip select instructions are the instructions corresponding to the current module. After determining the module by using the chip select instructions, the register to be accessed can be identified by using the address information. In subsequent steps, the address information can be modified to sequentially access all registers within the current module.

Step S200, writing a test case for the module based on the parameter information. In this step, based on the address information of the register corresponding to the current module and other required parameter information obtained in Step S100, a test case is written. This allows for sequential access to the registers according to the address information in subsequent steps to verify the module. The parameter information may include read/write bit information, buffer information, data information, and other parameters related to specific verification. Additionally, once the test case is written, it can also set whether there is an SPI flash device connected to the chip under test. In the test case, there is a designated marker position to indicate the presence of an SPI flash device on the chip under test. Typically, placing a “1” in this marker position indicates that there is an SPI flash device connected, while a “0” indicates there is no SPI flash device connected. Thus, by setting the numerical information at the corresponding position in the test case, it can be determined whether an SPI flash device is connected to the chip under test. When it is determined that there is an SPI flash device connected, data from the SPI flash is loaded into the registers of the current module within the chip under test by configuring the SPI master register within the chip. In this invention, the registers within the chip under test can operate in both master and slave modes. When loading data from the SPI flash on power-up, it operates in master mode, and once loading is complete, it automatically switches to slave mode.

Step S300, driving the parameter information in the test case onto an SPI bus at a top level of the chip under test through a driver, accessing at least one register of a current module of the chip under test, and obtaining an access result. In this step, the parameter information from the test case includes, but is not limited to, chip select value information of modules, address information of registers, read/write bit information, buffer information, and data format, among various other parameters relevant to verification. This information determines which register is accessed and which module is verified. By driving the various parameter information onto the SPI bus, each register can be accessed via the SPI bus instead of the chip bus. Furthermore, different chips under test may have different forms of SPI flash device connectivity. If no SPI flash device is connected to the chip under test, it means that the data from the SPI fails to load onto the registers in the current module, in this case, the original data within the registers is to be accessed. Conversely, if an SPI flash device is connected to the chip under test, the data loaded onto the registers from the SPI flash is to be accessed. Regardless of whether accessing the original data within the registers or data loaded onto the registers from the SPI flash, the access operations specifically include reading data from the registers, writing data to the registers, and reading the written data to complete read/write operations on the registers. Here, reading data from the registers can either be the original data on the registers or the data loaded from the SPI flash onto the registers, while writing data to the registers primarily involves writing pre-designed verification data into the registers based on verification requirements. Moreover, regardless of the specific access operations on the registers, an access result will always be obtained after access. For instance, when the access operation is reading data from the registers, the access result will be the data obtained after reading. When the operation is writing data to the registers and then reading the written data, the access result will be the data obtained after reading, as the written data is pre-designed known data and does not require further acquisition.

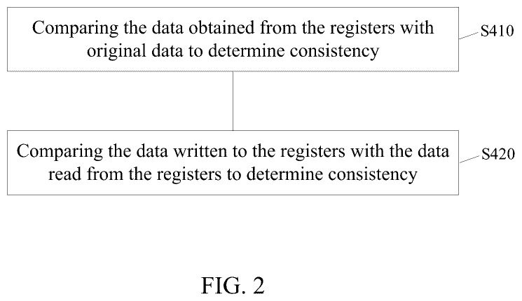

Step S400, verifying the access result to determine whether a current register of the current module is normal. This step primarily verifies whether the read and write operations on the current register are normal. As shown in FIG. 2, depending on the different access operations in Step S300, step of verifying the access result specifically includes the following sub-steps:

Step S410, comparing the data obtained from the registers with original data to determine consistency. In this step, since the chip under test may be in one of two forms-connected or not connected with an SPI flash device, data in the registers may also take on one of two forms either original data or data loaded from the SPI flash. Data in both forms is compared with the original data to determine consistency. If they are consistent, it indicates that the read operation on the registers is correct; if not, a correction operation will be performed on the read operation after verification is complete.

Step S420, comparing the data written to the registers with the data read from the registers to determine consistency. In this step, the data written to the register is known data that has been designed and prepared in advance according to the verification requirements. By reading the data back from the register and comparing it with the written data, it can be determined if there is any error in the writing and reading operations on the register. If they are consistent, it indicates that normal write and read operations can be performed on the register. If they are inconsistent, it indicates an error in the reading and writing operations on the register, and an error correction is required for the reading and writing operations on the register.

Step S500, repeating steps S200 to S400 until all registers of the current module have been verified. As mentioned above, at this point, the verification process for at least one register's read and write functionality in the current module has been completed. If the current module has multiple registers, repeat steps S200 to S400 as many times as there are registers in the current module. If the current module has only one register, no repetition is needed. During the repetition process, only the address information of the registers in the test cases needs to be changed, that is, the address of the previously accessed register in the test case is changed to the address of the next register to be accessed.

Step S600, repeating steps S100 to S500 until all modules of the chip have been verified. As mentioned above, at this point, the verification process for all functionalities of a module of the chip under test has been completed. If the chip under test has multiple modules, repeat steps S100 to S500 as many times as there are modules in the chip under test. If the chip under test has only one module, no repetition is needed.

As described above, in the chip verification method based on SPI of the present invention, the access to the registers of the chip under test can be accomplished solely through the SPI bus, without relying on the chip bus for access operations. This alleviates the burden the chip bus, allowing the chip bus to perform other operations more efficiently, thus improving the overall performance of the chip. Additionally, in the present invention, the SPI bus is exclusively used for accessing registers, which significantly reduces the probability of errors in accessing registers compared to the chip bus, thereby enhancing the overall verification efficiency of the chip.

The above-mentioned embodiments only represent several embodiments of the present invention, and the descriptions thereof are relatively specific and detailed, but should not be construed as limiting the scope of the patent invention. It should be pointed out that for those skilled in the art, several modifications and improvements can be made without departing from the concept of the present invention, which all belong to the protection scope of the present invention. Therefore, the scope of protection of the patent of the present invention shall be subject to the appended claims.

What is claimed is:

1. A chip verification method based on SPI, comprising the following steps:
(a) obtaining parameter information of a module of a chip under test and a corresponding register within the module;
(b) writing a test case for the module based on the parameter information;
(c) driving the parameter information in the test case onto an SPI bus at a top level of the chip under test through a driver, accessing at least one register of a current module of the chip under test, and obtaining an access result;
(d) verifying the access result to determine whether a current register of the current module is normal;
(e) repeating steps (b) to (d) until all registers of the current module have been verified; and
(f) repeating steps (a) to (e) until all modules of the chip have been verified.

2. The chip verification method based on SPI as claimed in claim 1, further comprising setting whether there is an SPI flash device connected in the chip under test within the test case.

3. The chip verification method based on SPI as claimed in claim 2, when an SPI flash device is connected in the chip under test, loading data information from the SPI flash into the registers of the current module of the chip under test by configuring an SPI master register within the chip under test.

4. The chip verification method based on SPI as claimed in claim 3, wherein said accessing the at least one register of the current module of the chip under test in step (c) specifically comprises accessing the data information of the SPI flash loaded onto the registers.

5. The chip verification method based on SPI as claimed in claim 2, wherein when no SPI flash device is connected in the chip under test, said accessing the at least one register of the current module of the chip under test in step (c) specifically comprises accessing original data in the registers.

6. The chip verification method based on SPI as claimed in claim 4, wherein said accessing the at least one register of the current module of the chip under test in step (c) specifically comprises reading data from the registers, writing data to the registers, and reading back the data written.

7. The chip verification method based on SPI as claimed in claim 6, wherein step (d) specifically comprises:
comparing the data obtained from the registers with original data to determine consistency; and
comparing the data written to the registers with the data read from the registers to determine consistency.

8. The chip verification method based on SPI as claimed in claim 1, wherein the parameter information comprises chip select instructions of the module and address information of the registers.
